(19) United States
(12) Patent Application Publication
(10) Pub. No.: US 2018/0095597 A1
(43) Pub. Date: Apr. 5, 2018

(54) DRIVING METHOD, TOUCH SENSING CIRCUIT, AND TOUCH DISPLAY DEVICE

(71) Applicant: LG DISPLAY CO., LTD., Seoul (KR)

(72) Inventors: Youngho KWON, Daegu (KR); SungUk BYUN, Daegu (KR); MinWoo HWANG, Gyeongsangbuk-do (KR); Sangsoo LEE, Gyeongsangbuk-do (KR)

(73) Assignee: LG DISPLAY CO., LTD., Seoul (KR)

(21) Appl. No.: 15/379,954

(22) Filed: Dec. 15, 2016

(30) Foreign Application Priority Data
Sep. 30, 2016 (KR) 10-2016-0126391

(51) Int. Cl. G06F 3/041; G06F 3/044

(52) U.S. Cl. CPC G06F 3/0418; G06F 3/044

(57) ABSTRACT

A touch display device includes a plurality of touch electrodes that are arranged outside or inside a display panel and a touch sensing circuit that outputs a touch driving signal to drive at least one of the plurality of touch electrodes and senses a touch or a touch position, the touch driving signal output in each touch section for the touch mode includes a plurality of waveforms to which a rectangular wave is modulated, and each of the plurality of waveforms includes one or more different amplitudes in a rising section and a falling section. Accordingly, it is possible to prevent electromagnetic interference (EMI).

### CROSS-REFERENCE TO RELATED APPLICATIONS

This application claims priority from Korean Patent Application No. 10-2016-0126391 filed on Sep. 30, 2016, which is hereby incorporated by reference for all purposes as if fully set forth herein.

### BACKGROUND

### Field of the Invention

The present invention relates to a display device, and more particularly, to a driving method, a touch sensing circuit, and a touch display device.

### Description of the Related Art

With advancement of information-oriented societies, various kinds of demands for display devices for displaying images have increased, and various types of display devices have been used, such as a liquid crystal display device (LCD), a plasma display panel (PDP), and an organic light-emitting display device (OLED).

Among such display devices, touch display devices that can provide a touch-based input system enabling a user to easily and intuitively input information or commands in addition to a normal input system using buttons, keyboards, mouse, and the like are known.

In order to provide such a touch-based input system, such touch display devices need to detect a user's touch and accurately detect a touched coordinate (a touch position).

For this purpose, a capacitive touch system that detects a touch and a touch coordinate on the basis of a variation in capacitance between plural touch electrodes disposed as touch sensors in a touch panel (a touch screen panel) or capacitance between the touch electrodes and a pointer such as a finger using the touch electrodes has been widely employed.

On the other hand, an electronic device such as a touch display device having a touch sensing function has to satisfy a condition that an electromagnetic interference (EMI) level is equal to or less than a predetermined level.

However, the touch display devices have a problem in that the EMI level is considerably high due to a touch driving signal for sensing a touch.

Particularly, when a touch driving signal applied to the touch electrodes to sense a touch is a pulse type (rectangular wave) signal having a predetermined frequency, an influence of the EMI may further increase.

There is also a problem in that the EMI deteriorates system stability of a touch display device, deteriorates touch sensing performance by affecting a sensing voltage at the time of sensing a touch or the like, or deteriorates display performance by affecting voltages required for displaying an image.

### SUMMARY

Accordingly, the present invention is directed to a driving method, a touch sensing circuit, and a touch display device that substantially obviate one or more of the problems due to limitations and disadvantages of the related art.

An object of the present invention is to provide a driving method, a touch sensing circuit, and a touch display device that can prevent electromagnetic interference (EMI).

Another object of the present invention is to provide a driving method, a touch sensing circuit, and a touch display device that can prevent EMI in a touch section and prevent unnecessary parasitic capacitance from being generated.

Still another object of the present invention is to provide a driving method, a touch sensing circuit, and a touch display device that can perform touch driving using a waveform modulation driving method capable of preventing EMI.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a touch display device has a display panel including a plurality of sub pixels and having a display mode for displaying an image and a touch sensing mode for sensing a touch. The touch display device may comprise a plurality of touch electrodes that are arranged outside or inside the display panel; and a touch sensing circuit that outputs a touch driving signal to drive at last one of the plurality of touch electrodes and senses a touch or a touch position. In the touch display device, the touch driving signal output in each touch section for the touch mode may include a plurality of waveforms to which a rectangular wave is modulated, and each of the plurality of waveforms may include one or more different amplitudes in a rising section and a falling section.

In another aspect, a driving method is provided for a touch display device having a display panel including a plurality of sub pixels and having a display mode for displaying an image and a touch sensing mode for sensing a touch. The driving method may comprise a display driving step of driving data lines and gate lines in a display section for the display mode; and a touch driving step of outputting a touch driving signal for driving at least one of a plurality of touch electrodes arranged outside or inside the display panel in a touch section for the touch mode. In the driving method, the touch driving step may include converting a rectangular wave of the touch driving signal into a plurality of waveforms of which amplitude is modulated in the touch section, and outputting the touch driving signal including the plurality of waveforms of which amplitude is modulated, and each of the plurality of waveforms may include one or more different amplitude levels in a rising section and a falling section.

In another aspect, a touch sensing circuit may be included in a touch display device having a display mode for displaying an image and a touch sensing mode for sensing a touch. The touch sensing circuit may comprise a driving circuit that outputs a touch driving signal for driving at least one of a plurality of touch electrodes; and a sensing circuit that detects a capacitance variation in each of the plurality of touch electrodes and senses a touch or a touch position. In the touch sensing circuit, the touch driving signal output in each touch section for the touch mode may include a plurality of waveforms to which a rectangular wave is modulated, and each of the plurality of waveforms may include one or more different amplitudes in a rising section and a falling section.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram schematically illustrating a system configuration of a touch display device according to exemplary embodiments;

FIG. 2 is a diagram illustrating a signal which is applied to a touch electrode in a display section and a touch section in the touch display device according to the exemplary embodiments;

FIG. 3 is a diagram illustrating display sections and touch sections based on a V-sensing method in the touch display device according to the exemplary embodiments;

FIG. 4 is a diagram illustrating display sections and touch sections based on an H-sensing method in the touch display device according to the exemplary embodiments;

FIG. 5 is a diagram illustrating parasitic capacitance components which are generated in the touch display device according to the exemplary embodiments;

FIG. 6 is a diagram illustrating load-free driving in the touch display device according to the exemplary embodiments;

FIG. 7 is a diagram illustrating an electromagnetic interference (EMI) measurement result in touch sections in the touch display device according to the exemplary embodiments;

FIG. 8 is a diagram illustrating waveform modulation driving for EMI improvement in the touch display device according to the exemplary embodiments;

FIGS. 9 to 16 are diagrams illustrating characteristics of touch driving signals TDS and LFDS and waveform modulation driving for the purpose of explaining waveform modulation driving characteristics in the touch display device according to the exemplary embodiments;

FIG. 17 is a diagram illustrating rectangular wave modulation patterns depending on touch sensitivity according to the exemplary embodiments;

FIG. 18 is a diagram illustrating a waveform modulation method for touch driving based on waveform modulation in the touch display device according to the exemplary embodiments;

FIG. 19 is a flowchart illustrating a driving method of the touch display device according to the exemplary embodiments;

FIG. 20 is a diagram illustrating a touch sensing circuit of the touch display device according to the exemplary embodiments;

FIG. 21 is a diagram illustrating an EMI improvement effect in the touch display device according to the exemplary embodiments; and

FIG. 22 is an enlarged view of an X region in FIG. 21.

### DETAILED DESCRIPTION

Hereinafter, some embodiments of the invention will be described in detail with reference to the accompanying illustrative drawings. In denoting elements of the drawings by reference numerals, the same elements will be referenced by the same reference numerals although the elements are illustrated in different drawings. In the following description of the invention, detailed description of known functions and configurations incorporated herein will be omitted when it may make the subject matter of the invention rather unclear.

Terms, such as first, second, A, B, (a), or (b) may be used herein to describe elements of the invention. Each of the terms is not used to define essence, order, sequence, or number of an element, but is used merely to distinguish the corresponding element from another element. When it is mentioned that an element is “connected” or “coupled” to another element, it should be interpreted that another element may be “interposed” between the elements or the elements may be “connected” or “coupled” to each other via another element as well as that one element is directly connected or coupled to another element.

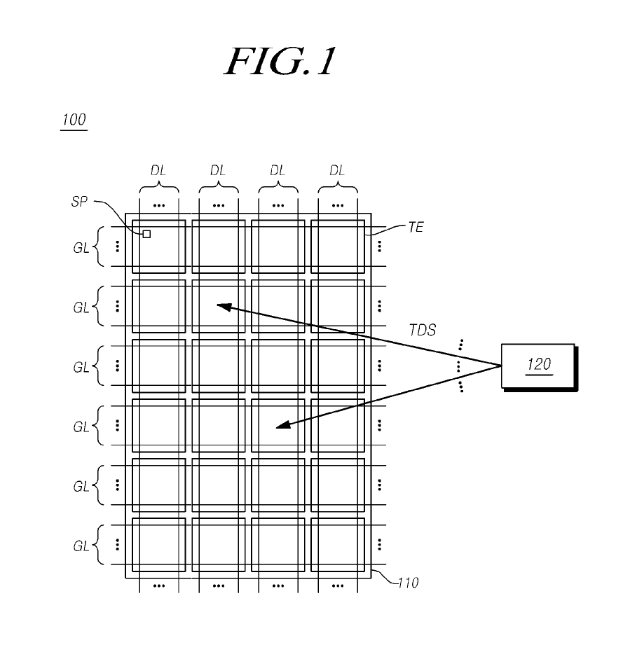

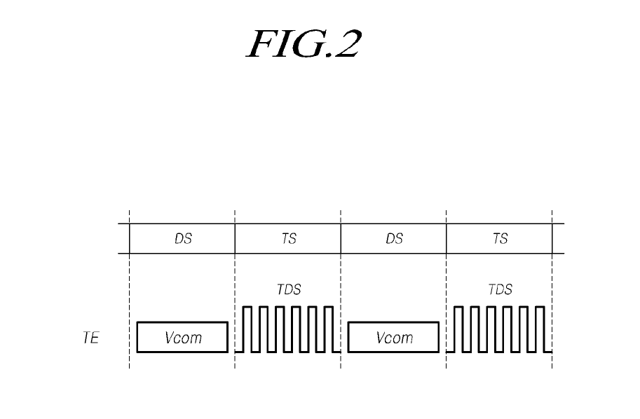

FIG. 1 is a diagram schematically illustrating a system configuration of a touch display device 100 according to the exemplary embodiments. FIG. 2 is a diagram illustrating a signal which is applied to a touch electrode TE in display sections DS and touch sections TS in the touch display device 100 according to the exemplary embodiments.

The touch display device 100 according to the exemplary embodiments includes a display panel 110 in which plural data lines DL supplied with data voltages corresponding to image signals and plural gate lines GL supplied with a scan signal are arranged and plural sub pixels SP defined by the data lines DL and the gate lines GL are arranged.

The touch display device 100 according to the exemplary embodiments has two operation modes including a display mode for displaying an image and a touch mode for sensing a touch.

In a display section for the display mode, data voltages corresponding to image signals are supplied to the data lines and a scan signal is sequentially supplied to the gate lines.

The touch display device 100 according to the exemplary embodiments includes a data driving circuit (not illustrated) and a gate driving circuit (not illustrated) for operation in the display mode.

In a display section DS in which the touch display device 100 according to the exemplary embodiments operates in the display mode, the data driving circuit (not illustrated) drives the data lines DL and the gate driving circuit (not illustrated) drives the gate lines GL.

The touch display device 100 according to the exemplary embodiments includes a touch sensing circuit 120 for operation in the touch mode.

In a touch section TS in which the touch display device 100 according to the exemplary embodiments operates in the touch mode, the touch sensing circuit 120 outputs a touch driving signal TDS of a pulse type (for example, a pulse width modulation (PWM) type) for driving at least one of plural touch electrodes TE electrically connected thereto via signal lines SL to sense a touch or a touch position.

As a touch electrode driving method, the touch sensing circuit 120 may sequentially at least one of the touch electrodes (a sequential driving method) or may simultaneously drive all the touch electrodes TE (a simultaneous driving method).

When the touch electrode driving method is the sequentially driving method or the simultaneous driving method, the touch sensing circuit 120 sequentially senses a touch and a touch position using a signal received from at least one of the touch electrodes TE as a sensing process of sensing (detecting) a touch and/or a touch position.

On the other hand, the touch sensing circuit 120 may detect a capacitance variation and sense a touch and/or a touch position on the basis of the detected capacitance variation. That is, the touch display device 100 according to the exemplary embodiments can sense a touch using a capacitance-based touch sensing method.

The capacitance-based touch sensing method includes a self-capacitance-based touch sensing method of detecting a capacitance variation between a pointer such as a finger or a pen and the touch electrode TE to sense a touch and a mutual-capacitance-based touch sensing method of detecting a capacitance variation between two types of touch sensors to sense a touch.

The mutual-capacitance-based touch sensing method is a method of detecting a capacitance variation between two types of touch sensors (a driving electrode and a receiving electrode) to sense a touch using a driving electrode (which is also referred to as a Tx electrode) supplied with the touch driving signal TDS and a receiving electrode (which is also referred to as an Rx electrode) corresponding to the driving electrode.

In the mutual-capacitance-based touch sensing method, the driving electrode (Tx electrode) supplied with the touch driving signal TDS among the two types of touch sensors corresponds to the touch electrode TE in this specification.

The self-capacitance-based touch sensing method is a method of supplying a touch driving signal to the touch electrode TE and detecting a signal from the touch electrode TE supplied with the touch driving signal to detect the capacitance variation. The touch electrode TE corresponding to one type of touch sensor functions as the driving electrode and the receiving electrode which are used in the mutual-capacitance-based touch sensing method.

The touch display device 100 according to the exemplary embodiments may perform touch driving and touch sensing using the self-capacitance-based touch sensing method or may perform the touch driving and the touch sensing using the mutual-capacitance-based touch sensing method.

In the following description, for the purpose of convenience of explanation, it is assumed that the touch driving and the touch sensing are performed using the self-capacitance-based touch sensing method.

Accordingly, the touch sensing circuit 120 can drive at least one of the touch electrodes TE and detect a capacitance variation of the touch electrodes TE on the basis of a signal received from the touch electrodes to sense a touch and/or a touch position.

On the other hand, the touch electrodes TE functioning as touch sensors may be arranged in a touch panel (not illustrated) which is present outside the display panel 110 or may be disposed inside the display panel 110.

In this way, when the touch electrodes TE are disposed in the display panel 110, the touch electrodes TE can be arranged in an in-cell type or an on-cell type.

On the other hand, when the touch display device 100 according to the exemplary embodiments operates in the display mode, a common voltage Vcom can be applied to all the sub pixels.

For this purpose, a common voltage electrode supplied with the common voltage Vcom is disposed in the display panel 110.

When the touch electrodes TE are disposed inside the display panel 110, the touch electrodes TE can function as a common voltage electrode which is supplied with the common voltage Vcom in the display sections DS.

When the touch display device 100 is a liquid crystal display device, the common voltage Vcom is used to cause a potential difference from a pixel voltage (corresponding to a data voltage) of each sub pixel and to express gray scales of the sub pixel.

As described above, when the touch electrodes TE are used as the common voltage electrode, the touch electrodes TE functions as the common voltage electrode in the display section DS and functions as the touch sensor in the touch section TS in the touch display device 100 according to the exemplary embodiments as illustrated in FIG. 2.

Referring to FIG. 2, the display section DS and the touch section TS are defined by temporally dividing one frame.

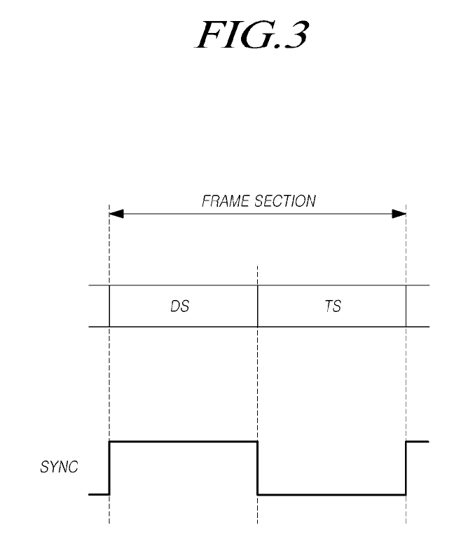

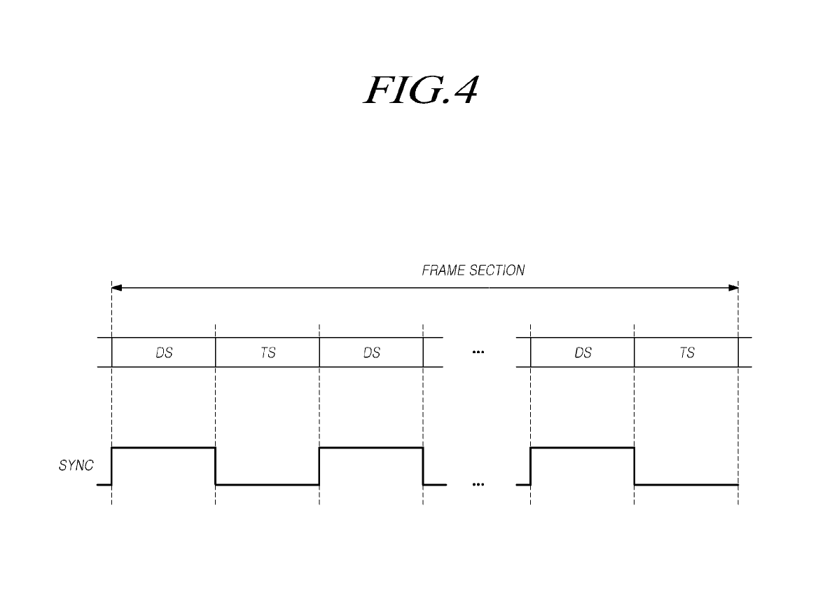

Depending on the methods of temporally dividing one frame into the display sections DS and the touch sections TS, the touch sensing method can be classified into a V-sensing method illustrated in FIG. 3 and an H-sensing method illustrated in FIG. 4.

FIG. 3 is a diagram illustrating a display section DS and a touch section TS based on the V-sensing method in the touch display device 100 according to the exemplary embodiments. FIG. 4 is a diagram illustrating display sections DS and touch sections DS based on the H-sensing method in the touch display device 100 according to the exemplary embodiments

Referring to FIG. 3, in the V-sensing method, one frame is temporally divided into one display section DS and one or more touch sections TS.

In the one display section DS, the touch display device 100 performs display driving for one frame.

In the one or more touch sections (TS), the touch display device 100 senses a touch or a touch position for one frame.

Referring to FIG. 4, in the H-sensing method, one frame is temporally divided into two or more display sections DS and one or more touch sections TS.

In the two or more display sections DS, the touch display device 100 performs display driving for one frame.

In the two or more touch sections TS, the touch display device 100 senses a touch or a touch position for one frame.

Referring to FIGS. 3 and 4, the display section DS and the touch section TS can be defined by a synchronization signal SYNC.

The synchronization signal SYNC may be generated by a control element such as a timing controller and be transmitted to a circuit for the display driving (for example, the data driving circuit and the gate driving circuit) and a circuit for the touch driving (for example, the touch sensing circuit 120).

Referring to FIGS. 3 and 4, in the synchronization signal SYNC, a high-level section (or a low-level section) corresponds to the display section DS, and the low-level section (or the high-level section) corresponds to the touch section TS.

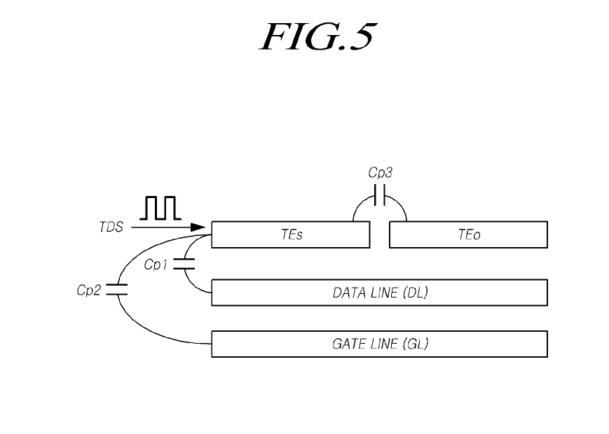

FIG. 5 is a diagram illustrating parasitic capacitance components Cp1, Cp2, and Cp3 generated in the touch display device 100 according to the exemplary embodiments.

Referring to FIG. 5, when a touch driving signal TDS is supplied to one or more touch electrodes TEs, the touch electrodes TEs supplied with the touch driving signal TDS can form the parasitic capacitance component Cp1 in cooperation with the data line DL, forms the parasitic capacitance component Cp2 in cooperation with the gate line GL, and form the parasitic capacitance component Cp3 in cooperation with another touch electrode TEo not supplied with the touch driving signal TDS.

In this way, the parasitic capacitance components Cp1, Cp2, and Cp3 generated in the touch section TS may function as a load in the touch sensing to decrease sensing accuracy.

Accordingly, the touch display device 100 according to the exemplary embodiments can perform touch driving capable of preventing or reducing generation of the parasitic capacitance components Cp1, Cp2, and Cp3 functioning as a load at the time of sensing a touch when at least one of the touch electrodes TE is sequentially driven in the touch section TS. This touch driving is referred to as load-free driving.

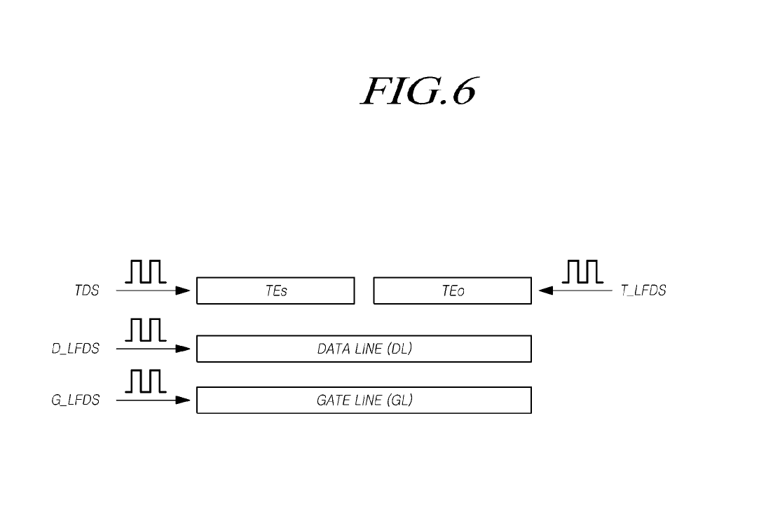

FIG. 6 is a diagram illustrating the load-free driving of the touch display device 100 according to the exemplary embodiments.

Referring to FIG. 6, the touch display device 100 according to the exemplary embodiments can supply a load-free driving signal D_LFDS to all or a part of the data lines DL when a touch driving signal TDS is supplied to one or more touch electrodes TEs in the touch section TS.

Some data lines DL supplied with the load-free driving signal D_LFDS among the data lines DL may be data lines arranged at positions corresponding to the touch electrodes TEs supplied with the touch driving signal TDS.

The load-free driving signal D_LFDS supplied to all or some of the data lines DL may be a touch driving signal TDS or a signal corresponding to the touch driving signal TDS.

When the load-free driving signal D_LFDS corresponds to the touch driving signal TDS, the load-free driving signal D_LFDS may have the same frequency as the touch driving signal TDS, the same phase as the touch driving signal TDS, and the same amplitude as the touch driving signal TDS.

Accordingly, a potential difference is not generated between the touch electrode TEs supplied with the touch driving signal TDS and the data line DL supplied with the load-free driving signal D_LFDS and it is thus possible to prevent the parasitic capacitance Cp1 from being formed between the touch electrode TEs supplied with the touch driving signal TDS and the data line DL supplied with the load-free driving signal D_LFDS.

Referring to FIG. 6, the touch display device 100 according to the exemplary embodiments can supply a load-free driving signal G_LFDS to all or some of the gate lines GL when a touch driving signal TDS is supplied to one or more touch electrodes TEs in the touch section TS.

Some gate lines GL supplied with the load-free driving signal D_LFDS among the gate lines GL may be gate lines arranged at positions corresponding to the touch electrodes TEs supplied with the touch driving signal TDS.

The load-free driving signal G_LFDS supplied to all or some of the gate lines GL may be a touch driving signal TDS or a signal corresponding to the touch driving signal TDS.

When the load-free driving signal G_LFDS corresponds to the touch driving signal TDS, the load-free driving signal G_LFDS may have the same frequency as the touch driving signal TDS, the same phase as the touch driving signal TDS, and the same amplitude as the touch driving signal TDS.

Accordingly, a potential difference is not generated between the touch electrode TEs supplied with the touch driving signal TDS and the gate line GL supplied with the load-free driving signal G_LFDS and it is thus possible to prevent the parasitic capacitance Cp2 from being formed between the touch electrode TEs supplied with the touch driving signal TDS and the gate line GL supplied with the load-free driving signal G_LFDS.

Referring to FIG. 6, the touch display device 100 according to the exemplary embodiments can supply a load-free driving signal T_LFDS to another touch electrode TEo not supplied with a touch driving signal TDS when the touch driving signal TDS is supplied to one or more touch electrodes TEs in the touch section TS.

The another touch electrode TEo supplied with the load-free driving signal T_LFDS among the touch electrodes TE may be a touch electrode TE arranged adjacent to the touch electrode TEs supplied with the touch driving signal TDS or all the other touch electrodes TE.

The load-free driving signal T_LFDS supplied to the another touch electrode TEo may be a touch driving signal TDS or a signal corresponding to the touch driving signal TDS.

When the load-free driving signal T_LFDS corresponds to the touch driving signal TDS, the load-free driving signal T_LFDS may have the same frequency as the touch driving signal TDS, the same phase as the touch driving signal TDS, and the same amplitude as the touch driving signal TDS.

Accordingly, a potential difference is not generated between the touch electrode TEs supplied with the touch driving signal TDS and the another touch electrode supplied with the load-free driving signal T_LFDS and it is thus possible to prevent the parasitic capacitance Cp3 from being formed between the touch electrode TEs supplied with the touch driving signal TDS and the another touch electrode TEo supplied with the load-free driving signal T_LFDS.

In the above-mentioned lad-free driving, the load-free driving signal (at least one of D_LFDS, G_LFDS, and T_LFDS) supplied to at least one of the dta line DL, the gate line GL, and the touch electrode TEo may be the same signal as the touch driving signal TDS or may be a signal different from or similar to the touch driving signal TDS as long as parasitic capacitance can be removed.

Even when the touch sensing circuit 120 outputs a load-free driving signal completely equal to the touch driving signal TDS, the frequency, phase, voltage (amplitude), or signal waveform (signal shape) of the load-free driving signal actually supplied to the data line DL, the gate line, or the touch electrode TEo may be different from the frequency, phase, voltage (amplitude), or signal waveform (signal shape) of the touch driving signal TDS due to panel characteristics such as a load and a resistive-capacitive (RC) delay.

In this way, a degree of difference between an output state and an actual supply state of the load-free driving signal may vary depending on a panel position (that is, a horizontal or vertical position of the data line DL, the gate line GL, or the touch electrode TEo supplied with the load-free driving signal).

In consideration of the fact that the output state and the actual supply state of the load-free driving signal are different from each other depending on the panel characteristics and the supply position, the touch driving signal or the load-free driving signal can be output after the output state thereof such that the actually supplied load-free driving signal is equal to the actually supplied touch driving signal.

Accordingly, the touch driving signal output from the touch sensing circuit 120 and the load-free driving signal output from a load-free driving circuit (for example, the touch sensing circuit, the data driver, or the gate driver) may be equal to each other in all of frequency, phase, voltage (amplitude), and signal waveform (signal shape) or may be different from each other in at least one of frequency, phase, voltage (amplitude), and signal waveform (signal shape).

On the other hand, in the touch display device 100, when at least one of the touch electrodes TE is sequentially driven using a touch driving signal TDS of a pulse type having a single frequency (for example, several tens of KHz to several hundreds of KHz) in the touch section TS, electromagnetic interference (EMI) may occur due to a variation in voltage level of the touch driving signal TDS.

Particularly, in the touch display device 100, when at least one of the touch electrodes TE is sequentially driven using a touch driving signal TDS of a pulse type (a rectangular wave) having a single frequency (for example, several tens of KHz to several hundreds of KHz) in the touch section TS and load-free driving of at least one of another touch electrode TEo, the data line DL, and the gate line GL is further performed at this time, the EMI due to the touch driving signal TDS may be intensified.

In the exemplary embodiments, the touch driving signal which is supplied to the touch electrodes TEs to check a touch in a touch section TS is referred to as a first touch driving signal TDS and the load-free driving signal LFDS which is supplied to another touch electrode TEo, the gate line GLm, and the data line DL to correspond to the first touch driving signal is referred to as a second touch driving signal LFDS. The second touch driving signal LFDS may be a signal for preventing parasitic capacitance generated between a touch electrode TEo adjacent to the touch electrode TEs, the gate line GL, and the data line DL.

That is, when a touch driving signal supplied in a touch section TS is mentioned without any distinction in the exemplary embodiments, the touch driving signal includes both the first and second touch driving signals TDS and LFDS.

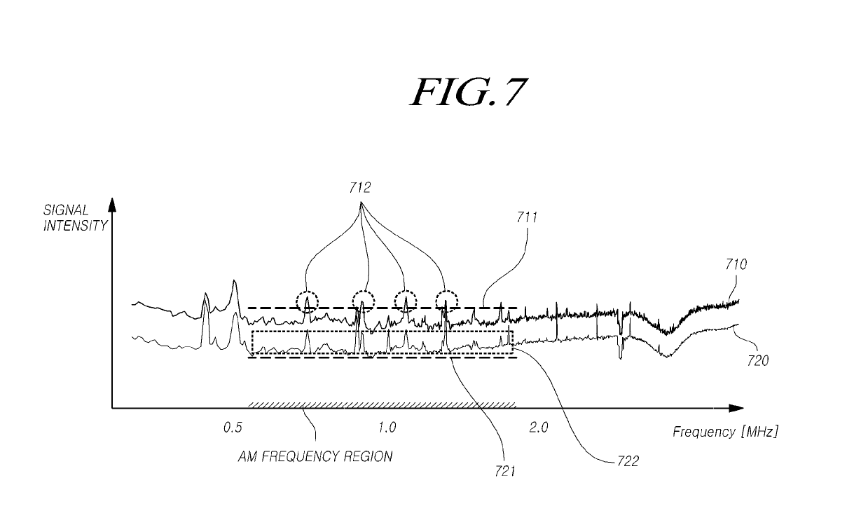

FIG. 7 is a diagram illustrating an EMI measurement result in a touch section TS in the touch display device 100 according to the exemplary embodiments.

Referring to FIG. 7, when the touch display device 100 drives the touch electrodes TE using the touch driving signals TDS and LFDS having a single frequency of 100 KHz, EMI may occur in an amplitude modulation (AM) frequency region (for example, about 500 KHz to about 1,605 KHz) due to the touch driving signals TDS and LFDS.

FIG. 7 is a graph illustrating an upper-limit measured value 710 and an average measured value 720 of an EMI signal by frequencies which are obtained by measuring intensity of the EMI signal by frequencies.

From the measurement result, it can be confirmed that there is a point 712 at which the upper-limit measured value 710 of the EMI signal is greater than a reference upper limit value 711 which is a minimum upper limit value for satisfying an EMI condition in the AM frequency region.

From the measurement result, it can be confirmed that there is a point 722 at which the average measured value 720 of the EMI signal is greater than a reference average value 721 which is a minimum upper limit value for satisfying an EMI condition in the AM frequency region.

That is, as the measurement result, the upper-limit measured value 710 and the average measured value 720 of the EMI signal may not satisfy the EMI condition in the AM frequency region.

Therefore, the touch display device 100 according to the exemplary embodiments can provide a waveform modulation driving method to suppress an EMI phenomenon due to the touch driving signals TDS and LFDS.

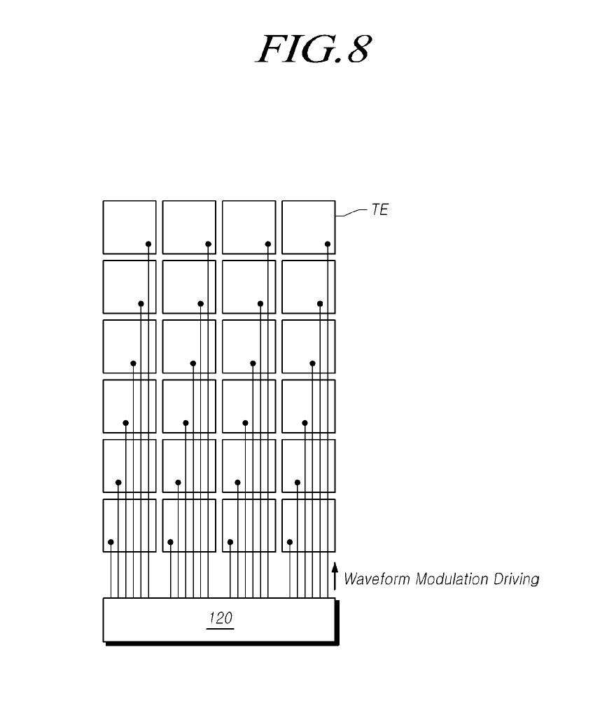

FIG. 8 is a diagram illustrating waveform modulation driving for EMI suppression in the touch display device 100 according to the exemplary embodiments.

Referring to FIG. 8, the touch sensing circuit 120 of the touch display device 100 according to the exemplary embodiments modulates the waveforms of the touch driving signal, that is, the first touch driving signal TDS and the second touch driving signal LFDS into various shapes to drive the touch display device 100.

In this touch driving method, a waveform having different amplitude levels, that is, two or more amplitude levels or a trapezoidal waveform or a triangular (sawtooth-shaped) waveform having amplitude varying with a predetermined gradient may be used as a waveform of the first touch driving signal TDS for driving the touch electrodes TE.

A waveform of the second touch driving signal LFDS which is supplied to at least one of another adjacent touch electrode, the gate line GL, and the data line DL to correspond to the first touch driving signal TDS supplied to the touch electrode TE can be modulated in the same shape as the first touch driving signal TDS.

This driving is referred to as “waveform modulation driving” in this specification.

According to the waveform modulation driving, the first and second touch driving signals TDS and LFDS output from the touch sensing circuit 120 may have various types of waveforms. The second touch driving signal LFDS may be supplied from the touch sensing circuit 120 or may be supplied from the gate driver or the data driver.

As described above, by employing the waveform modulation driving according to the exemplary embodiments, the waveforms of the touch driving signals TDS and LFDS output from the touch sensing circuit 120 do not vary fast in amplitude but vary gradually, thereby relaxing the EMI phenomenon.

When each waveform of the touch driving signals TDS and LFDS has two or more different amplitude levels or has an amplitude level varying with a predetermined gradient, the EMI phenomenon is suppressed in the touch display device 100 according to the exemplary embodiment in comparison with a case in which the waveform varies fast from a “low” level to a “high” level.

When each waveform of the touch driving signals TDS and LFDS increases gradually, a voltage difference between the “low” level and the “high” level is not large, thereby suppressing the EMI phenomenon. Since each waveform of the first touch driving signal TDS and the second touch driving signal LFDS rises in a charge share type, a fast waveform variation does not occur, thereby suppressing the EMI phenomenon.

In other words, the exemplary embodiments provides a touch sensing method, a touch sensing circuit 120, and a touch display device 100 that can suppress the EMI phenomenon and perform touch driving using the waveform modulation driving method.

Hereinafter, the waveform modulation driving of driving the touch electrodes TE by modulating waveforms of the touch driving signals TDS and LFDS will be described in more detail.

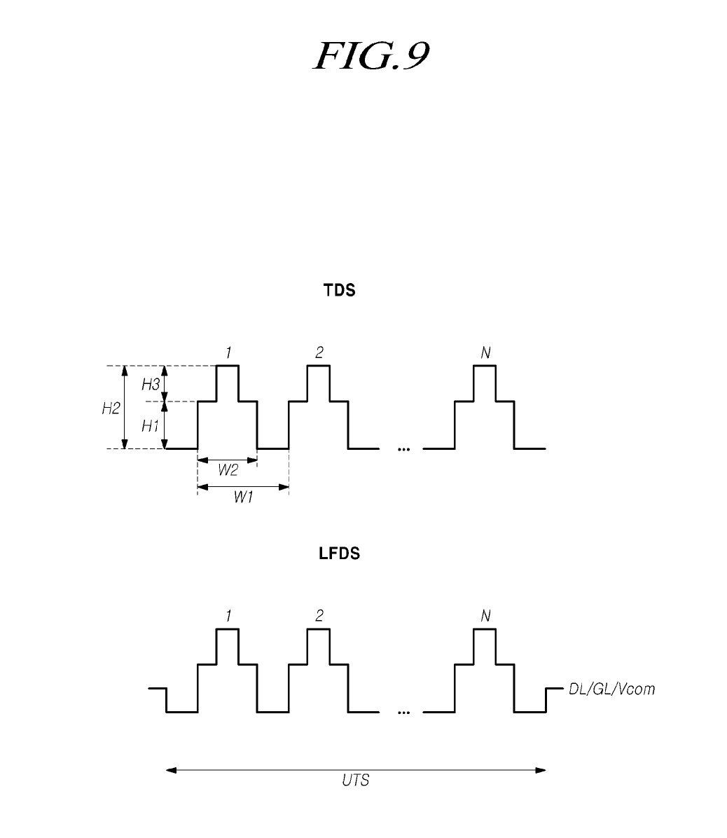

FIGS. 9 to 16 are diagrams illustrating characteristics of the touch driving signals TDS and LFDS and the waveform modulation driving for the purpose of explaining waveform modulation driving characteristics in the touch display device according to the exemplary embodiments.

Here, it is assumed that the first touch driving signal TDS is supplied to one touch electrode TE and the second touch driving signal LFDS is supplied to at least one of another touch electrode adjacent thereto, the gate line, and the data line to correspond to the first touch driving signal TDS in the touch section (see FIG. 6). Accordingly, the touch driving signals supplied to the touch display device 100 includes the first and second touch driving signals TDS and LFDS.

FIG. 9 is a diagram illustrating characteristics of the first touch driving signal TDS and the second touch driving signal LFDS in a unit touch section UTS in which the touch driving signals are output for the purpose of explaining the waveform modulation driving characteristics in the touch display device 100 according to the exemplary embodiments.

Each of the first and second touch driving signals TDS and LFDS includes plural waveforms (pulses) to which a rectangular wave is modulated and each waveform has two or more different amplitude levels. There is a section in which the touch electrodes TE are driven using the first touch driving signal TDS. When the first touch driving signal TDS is supplied, the second touch driving signal LFDS can be supplied to correspond to the first touch driving signal TDS.

FIG. 9 is a diagram illustrating the touch driving signals TDS and LFDS in a unit touch section UTS.

Referring to FIG. 9, a unit touch section UTS has a predetermined section length and the first touch driving signal TDS of a pulse type (a waveform to which a rectangular wave is modulated) output from the touch sensing circuit 120 in the unit touch section UTS has a predetermined frequency and a predetermined number of waveforms (pulses) N. The second touch driving signal LFDS output from the touch sensing circuit 120 (or the gate driver and the data driver) to correspond to the first touch driving signal TDS may have the same waveform as the first touch driving signal TDS. Here, it is assumed that the second touch driving signal LFDS is output from the touch sensing circuit 120.

The touch driving signals, that is, the first and second touch driving signals TDS and LFDS, output from the touch sensing circuit 120 in a unit touch section UTS include plural waveforms to which a rectangular wave is modulated, and each waveform has a high section W2 and a low section in one period W1. Here, the high section refers to a rising section in which a voltage increases and a falling section.

A ratio of the high section to one period can be defined as a duty ratio. The duty ratio can be expressed by W2/W1. The duty ratio may vary depending on the unit touch sections UTS and may be the same in all the unit touch sections UTS. By adjusting the duty ratio, it is possible to reduce power consumption (achieve low power) and to perform effective touch sensing.

Each waveform of the touch driving signals TDS and LFDS in FIG. 9 can be modulated to have a first amplitude level H1 and a second amplitude level H2. That is, the waveform can be modulated to have two or more amplitude levels, that is, to have two or more amplitude levels in an area corresponding to the high section of the waveform. H3 represents a difference between the second amplitude level H2 and the first amplitude level H1.

As illustrated in FIG. 9, the different amplitude levels of each waveform of the first and second touch driving signals TDS and LFDS of the touch driving signal may sequentially decrease to the edges from the center of the high section (H2→H1). That is, the high section of the waveform may have a section (a rising section) in which the amplitude level increases in a step shape and a section (a falling section) in which the amplitude level decreases in a step shape.

That is, the different amplitudes of each waveform of the first and second touch driving signals TDS and LFDS may sequentially increase from the edges of the high section to the center of the high section (from the rising section and the falling section to the center of the high section (H1→H2). That is, the amplitude of the waveform may increase or decrease gradually (increase or decrease in a step shape) in the rising section and the falling section.

The first touch driving signal TDS of the touch driving signal is a signal supplied to one touch electrodes TE and thus each waveform thereof varies from a low level to a high level in the touch mode. However, the second touch driving signal LFDS of the touch driving signal is a signal supplied to another touch electrode (Vcom voltage) adjacent to the touch electrode TE, the gate line, or the data line DL and thus may have a predetermined voltage level (a voltage supplied to DL, GL, or Vcom) in the display mode.

For example, in the display mode, the another touch electrode is supplied with a voltage corresponding to the touch driving signal, the gate line GL is supplied with a gate-high or gate-low voltage, and the data line DL is supplied with a data voltage. Accordingly, the waveform of the second touch driving signal LFDS has a predetermined potential in the display mode and is changed to a low level and then is changed to a high level in the touch mode.

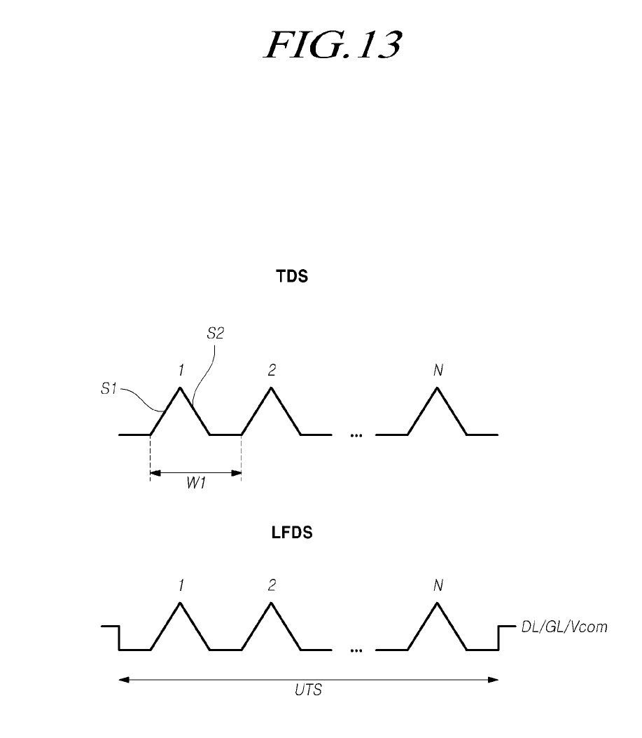

FIG. 9 illustrates an example in which each waveform of the first and second touch driving signals TDS and LFDS has two different amplitude levels, but the exemplary embodiments are not limited to this example and each waveform may have two or more different amplitude levels. The amplitude increases in a form of multiple steps when the number of different amplitudes increases, and the different amplitude levels may form a predetermined gradient as illustrated in FIG. 13 when the number of different amplitudes increases additionally.

Therefore, when each waveform of the first and second touch driving signals TDS and LFDS of the touch driving signal rises from the low section to the high section, the amplitude level increases gradually in a step shape to have an amplitude level corresponding to the center of the high section, and the voltages correspond to the amplitude levels share charges, thereby suppressing the EMI phenomenon.

That is, each waveform of the touch driving signals TDS and LFDS which are used in the waveform modulation driving method according to the exemplary embodiments does not rise from the “low” level to the second amplitude level H2, but rises to the first amplitude level H1 and then rises from the first amplitude level H1 to the second amplitude level H2, thereby suppressing the EMI phenomenon.

Particularly, when the first touch driving signal TDS and the second touch driving signal LFDS have waveforms of which the amplitude is modulated in the same way, it is possible to reduce parasitic capacitance between the touch electrode adjacent to the touch electrode TE supplied with the first touch driving signal TDS, the gate line, and the data line as described with reference to FIG. 6.

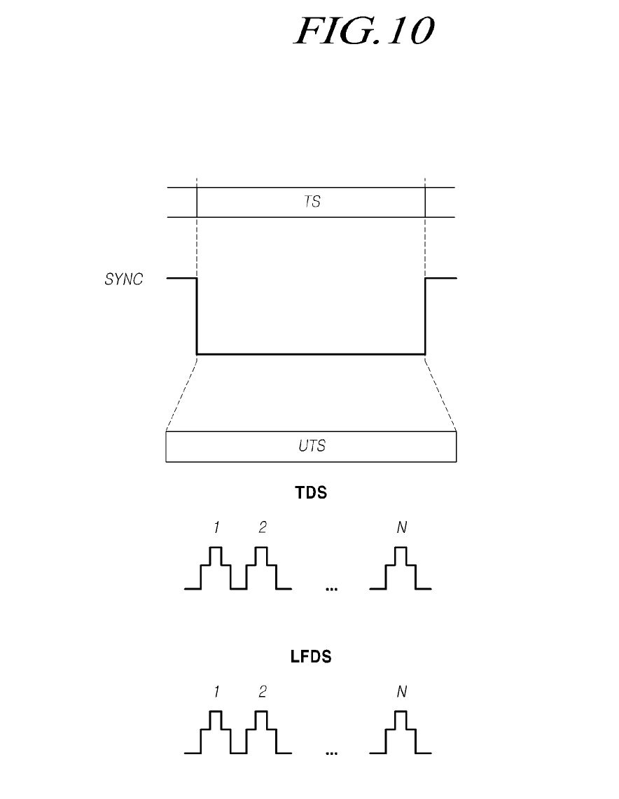

When the first touch driving signal TDS and the second touch driving signal LFDS have the above-mentioned amplitude-modulated waveforms, the EMI phenomenon in each driving signal can be reduced. Accordingly, it is preferable that the first and second touch driving signals TDS and LFDS be modulated in the same way as illustrated in FIGS. 9 and 10.

Referring to FIG. 10, a touch section TS may include one or more unit touch sections UTS, and the first and second touch driving signals TDS and LFDS having multiple waveforms are supplied in the unit touch section UTS.

Each waveform of the first and second touch driving signals TDS and LFDS has two or more different amplitude levels as illustrated in FIG. 9. Accordingly, the voltage level varies in a step shape when the touch driving signal varies from the low section to the high section.

In the drawings, the waveforms having different amplitude levels have the same frequency (period), but the waveforms of the first and second touch driving signals TDS and LFDS of the touch driving signal may have different periods (frequencies). That is, the waveforms of the first touch driving signal TDS may have different periods and the waveforms of the second touch driving signal LFDS may also have different periods.

In this way, in the touch display device according to the exemplary embodiments, when each waveform of the touch driving signals TDS and LFDS varies from the low section to the high section, the voltage level increases gradually, thereby decreasing EMI intensity.

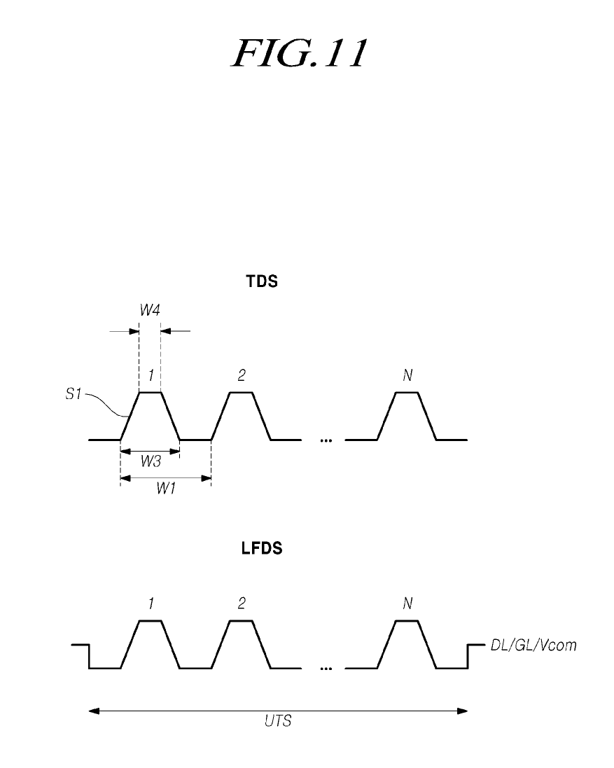

FIGS. 11 to 14 illustrate other examples of the exemplary embodiments in which a waveform is modulated in a shape having a predetermined slope (a shape having a gradient) when each waveform of the touch driving signals TDS and LFDS varies from the low section to the high section.

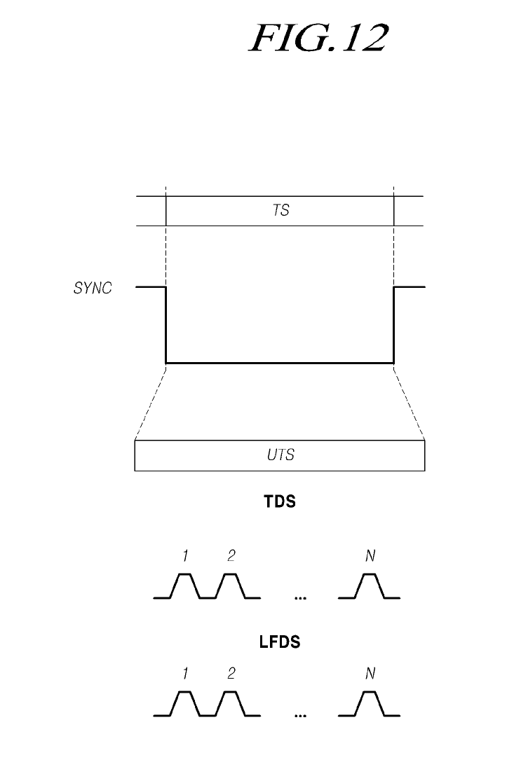

Referring to FIGS. 11 and 12, the touch driving signals TDS and LFDS of a pulse type output from the touch sensing circuit 120 may have a predetermined frequency and a predetermined number of waveforms (pulses) N.

Each waveform of the first and second touch driving signals TDS and LFDS of the touch driving signal has a shape to which a rectangular wave is modulated. Each waveform has a first high section W3 and a second high section W4 in one period W1. The second high section W4 may be included in the first high section W1 and has a predetermined slope S1 from the low section to the second high section W4.

For example, it is preferable that the frequencies of the first and second touch driving signals TDS and LFDS be less than 250 KHz in maximum Max, a slew rate range from 1 V/us to 1.6 V/us, and a threshold angle of the slope ranges from 45 degrees to 80 degrees. When the threshold angle of the slope is less than 45 degrees, touch sensing sensitivity decreases. When the threshold angle of the slope is greater than 80 degrees, the EMI intensity is similar to that in a case of a pulse type. The threshold angle of the slope (the gradient) may refer to a slope angle at which the amplitude rises to the high section with respect to the low section.

That is, the waveform illustrated in FIG. 9 has a structure in which two or more different amplitude levels increase in a step shape, and the waveform illustrated in FIG. 11 has a structure in which the amplitude level increases with a slope S1 having a gradient. This waveform is referred to as a trapezoidal waveform. That is, the amplitude level has a predetermined slope in the rising section and the falling section.

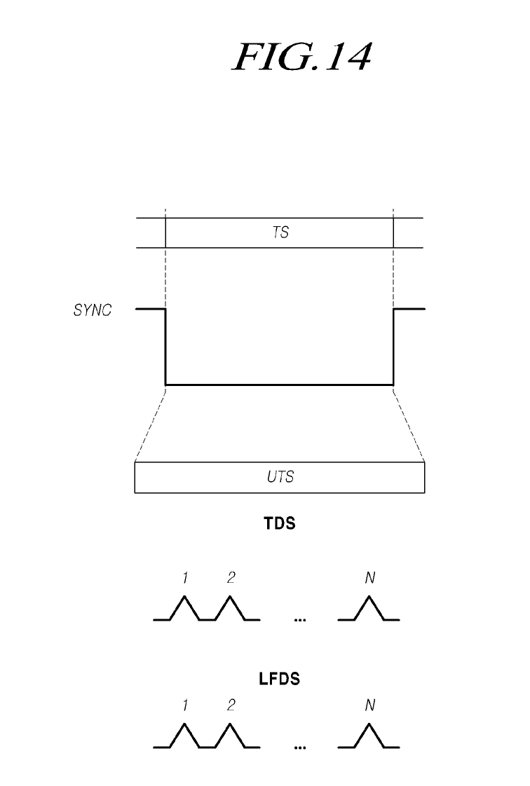

Referring to FIGS. 13 and 14, the first and second touch driving signals TDS and LFDS of the touch driving signal output from the touch sensing circuit 120 may have a predetermined frequency and a predetermined number of waveforms (pulses) N.

Each waveform of the first and second touch driving signals TDS and LFDS of the touch driving signal has a shape to which a rectangular wave is modulated. Each waveform includes a high section and a low section in one period W1. Each waveform may have predetermined slopes S1 and S2 from the center of the high section to both edges of the high section. The slopes S1 and S2 may have the same gradient or may have different gradients.

This waveform of the touch driving signals TDS and LFDS is referred to as a triangular waveform (sawtooth-shaped waveform). In this way, when each waveform is a triangular waveform, it is preferable that the frequencies of the first and second touch driving signals TDS and LFDS be less than 250 KHz in maximum Max, a slew rate range from 1 V/us to 1.6 V/us, and a threshold angle of the slope ranges from 45 degrees to 80 degrees. When the threshold angle of the slope is less than 45 degrees, touch sensing sensitivity decreases. When the threshold angle of the slope is greater than 80 degrees, the EMI intensity is similar to that in a case of a pulse type.

In FIGS. 11 to 14, each waveform of the touch driving signals TDS and LFDS gradually increases from the low section to the high section and it is thus possible to suppress the EMI intensity.

In FIGS. 11 to 14, amplitude modulation of a waveform is illustrated when the waveforms of the first and second touch driving signals TDS and LFDS of the touch driving signal are equal to each other, but only one driving signal of the first touch driving signal TDS and the second touch driving signal LFDS may be subjected to waveform modulation to drive the touch display device.

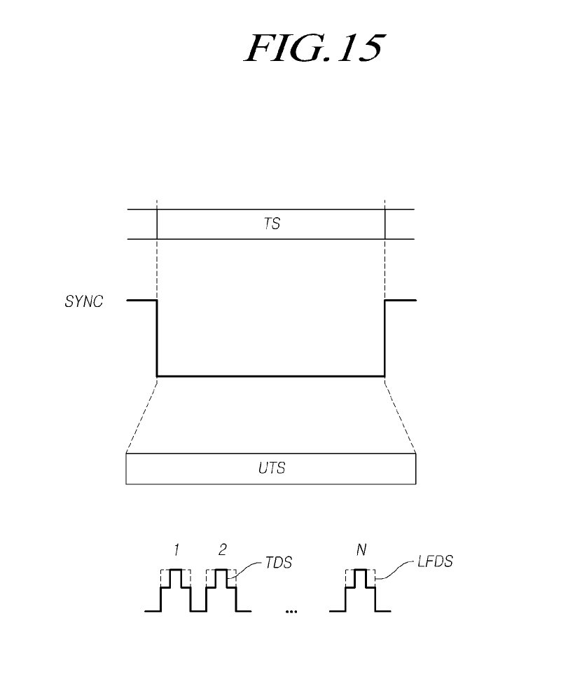

Referring to FIG. 15, each touch section TS may include one or more unit touch sections UTS, and the first and second touch driving signals TDS and LFDS including multiple waveforms are supplied in each unit touch section UTS.

In FIG. 15, a pulse type (rectangular) driving signal not subjected to amplitude modulation may be supplied as the first touch driving signal TDS supplied to one touch electrode TE and the modulated waveforms described above with reference to FIGS. 9 to 14 may be supplied as the waveform of the second touch driving signal LFDS supplied to the touch display device to correspond to the first touch driving signal TDS.

At this time, each waveform of the first touch driving signal TDS of the touch driving signal has a pulse-like shape, but the same is true when each waveform is not an AC type but another (DC) type.

Parasitic capacitance may be generated in a non-overlapping area of the first touch driving signal TDS (a dotted line) and the second touch driving signal LFDS (a solid line) in FIG. 15, but it is possible to suppress EMI due to the second touch driving signal LFDS by changing the second touch driving signal LFDS to a waveform to which a rectangular wave is modulated.

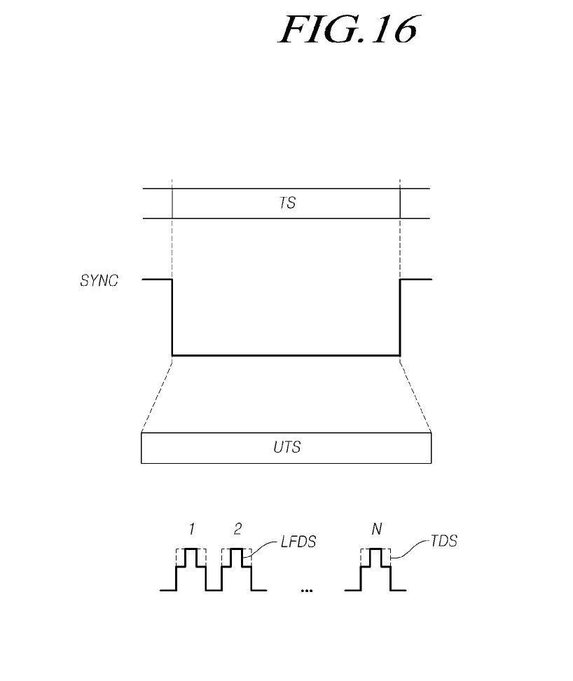

Referring to FIG. 16, on the contrary to FIG. 15, the waveforms to which a rectangular wave is modulated and which are described with reference to FIGS. 9 to 14 may be supplied as each waveform of the first touch driving signal TDS and a pulse type waveform may be supplied as each waveform of the second touch driving signal LFDS.

As described with reference to FIG. 15, the waveform of the first touch driving signal TDS and the waveform of the second touch driving signal LFDS are not equal to each other and thus parasitic capacitance may be formed between one touch electrode TE and another touch electrode adjacent thereto, the gate line, or the data line, but the EMI phenomenon due to the first touch driving signal TDS can be suppressed.

That is, the EMI intensity in FIGS. 15 and 16 increases than that when the waveforms of the first touch driving signal TDS and the second touch driving signal LFDS are equal to each other as illustrated in FIGS. 9 to 14, but the EMI phenomenon can be suppressed using the driving signal (the first or second touch driving signal TDS or LFDS) having a modulated waveform when one of the first and second touch driving signals TDS and LFDS is changed to a waveform to which a rectangular wave is modulated. Accordingly, the EMI intensity becomes less than that when the waveform modulation as in the exemplary embodiments is not performed.

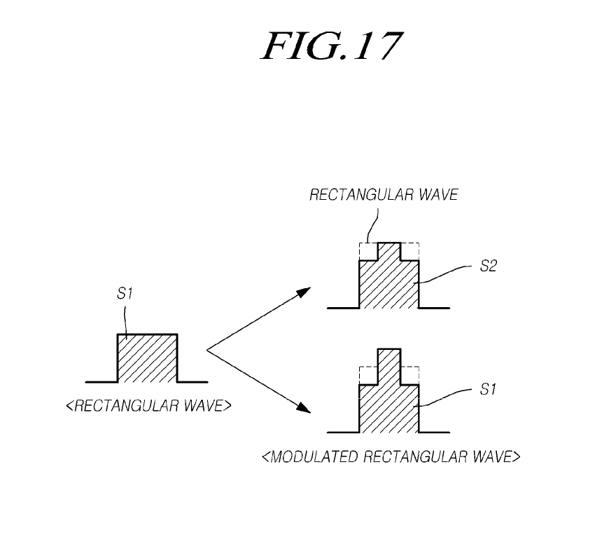

FIG. 17 is a diagram illustrating rectangular wave modulation patterns depending on touch sensitivity according to the exemplary embodiments.

Referring to FIG. 17, when the amplitude of a rectangular wave which is used for a touch driving signal is modulated, the modulated rectangular wave may have different amplitude levels as described above with reference to FIGS. 9 and 10.

When a rectangular wave is amplitude-modulated within the highest level of the rectangular wave, an area of the modulated rectangular wave S2 may be less than an area S1 of the rectangular wave associated with touch sensitivity. When the area of the modulated rectangular wave S2 decreases but is within a sensitivity range in which a touch can be recognized, it is possible to reduce power consumption.

When the area of a modulated rectangular wave S2 decreases the touch sensitivity, the rectangular wave can be amplitude-modulated to have a value higher than the highest level of the rectangular wave in the exemplary embodiments. That is, it is possible to modulate a rectangular wave such that the area of the modulate rectangular wave and the area of the rectangular wave can be maintained at the same value S1. This rectangular wave amplitude modulation can be applied to the touch driving signals described above with reference to FIGS. 11 to 15.

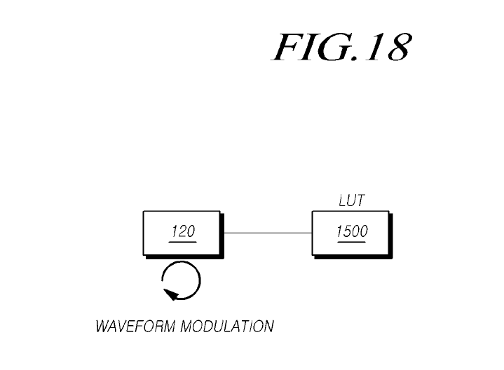

FIG. 18 is a diagram illustrating a waveform modulation method for touch driving based on waveform modulation in the touch display device according to the exemplary embodiments.

Referring to FIG. 18, the touch display device 100 according to the exemplary embodiments can perform the touch driving based on waveform modulation to sense a touch by modulating each waveform of the touch driving signals TDS and LFDS to a waveform having two or more different amplitude levels.

For this waveform modulating process, the touch display device 100 according to the exemplary embodiments may further include a lookup table 1500 that stores waveform modulation information.

The lookup table 150 may store frequency change information in addition to the waveform information described with reference to FIGS. 11, 13, 15, and 16. Accordingly, the plural waveforms included in the touch driving signal TDS have the same period (frequency) in FIGS. 10, 12, and 14, but may be modified to have different frequencies.

The waveform modulation information stored in the lookup table 150 may be classified by touch sections or unit touch sections. That is, in each touch section, the amplitude of a rectangular wave may be modulated using the information stored in the lookup table 1500 and the amplitude-modulated touch driving signal may be supplied to the display panel.

The touch sensing circuit 120 performs waveform modulation on the first touch driving signal TDS and the second touch driving signal LFDS of the touch driving signal with reference to the lookup table 1500. As illustrated in FIGS. 15 and 16, the waveform modulation may be performed on only one of the first touch driving signal TDS and the second touch driving signal LFDS of the touch driving signal.

As described above, by storing a list of modulation waveforms to be used for the waveform modulation in the lookup table 1500 and determining the waveform modulation pattern on the basis of the list, the touch display device 100 according to the exemplary embodiments can rapidly perform the waveform modulating process.

As described above, when the waveform modulating process is performed using the lookup table 1500, the modulated waveform has to be determined to help to suppress EMI intensity.

As another waveform modulating method, the waveform modulating process may be performed using an EMI noise measurement result.

In this regard, the touch sensing circuit 120 can modulate the waveforms of the touch driving signals TDS and LFDS to waveforms in which noise is avoided on the basis of the EMI noise measurement result.

Here, the EMI noise measurement result may be information which is output from a noise measuring device (not illustrated) mounted inside the touch display device 100 and is input to the touch sensing circuit 120 or may be information which is input to the touch display device 100 from an external noise measuring device (not illustrated).

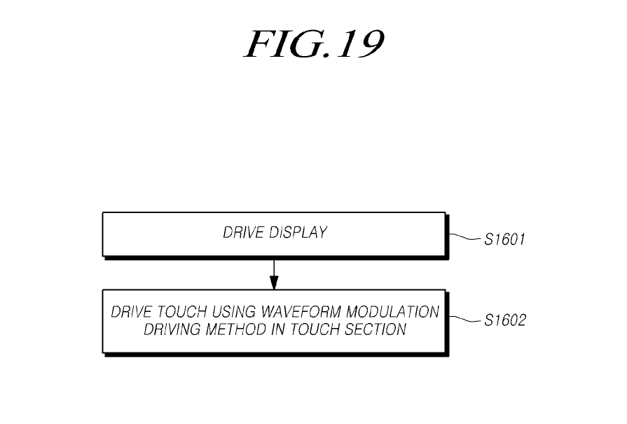

FIG. 19 is a flowchart illustrating a driving method of the touch display device according to the exemplary embodiments.

Referring to FIG. 19, the touch display device 100 according to the exemplary embodiments includes a display panel in which plural data lines and plural gate lines are arranged and plural sub pixels defined by the data lines and the gate lines are arranged and has a display mode for displaying an image and a touch mode for sensing a touch. Accordingly, a driving method for these two operation modes can be provided.

Referring to FIG. 19, the driving method of the touch display device 100 according to the exemplary embodiments includes a display driving step S1601 of causing the touch display device having the display mode for displaying an image and the touch sensing mode for sensing a touch to drive the data lines and the gate lines in a display section for the display mode and a touch driving step of outputting a touch driving signal for driving at least one of touch electrodes arranged inside or outside the display panel in a touch section for the touch sensing mode. The touch driving signal includes a first touch driving signal TDS which is supplied to one touch electrode TE and a second touch driving signal LFDS which is supplied to another touch electrode adjacent to the touch electrode TE, the gate lines GL, or the data lines DL.

The touch driving step includes a touch driving step S1602 of modulating each waveform of the touch driving signals TDS and LFDS having plural waveforms output in the touch section to a waveform having two or more different amplitude levels (from a rectangular wave) and performing touch driving.

On the other hand, one touch section may include two or more continuous unit touch sections.

The touch driving signals TDS and LFDS output in the two or more unit touch sections may have the same frequency or may have different frequencies.

According to the above-mentioned driving method, in the touch driving, the waveforms of the first touch driving signal TDS output from the touch electrode in one touch section can be modulated to have different amplitude levels by performing the touch driving based on waveform modulation and the waveforms of the second touch driving signal LFDS corresponding to the first touch driving signal TDS can also be modulated to have different amplitude levels, thereby relaxing EMI based on EMI charge share.

The touch sensing circuit 120 for performing the touch driving based on waveform modulation will be described below.

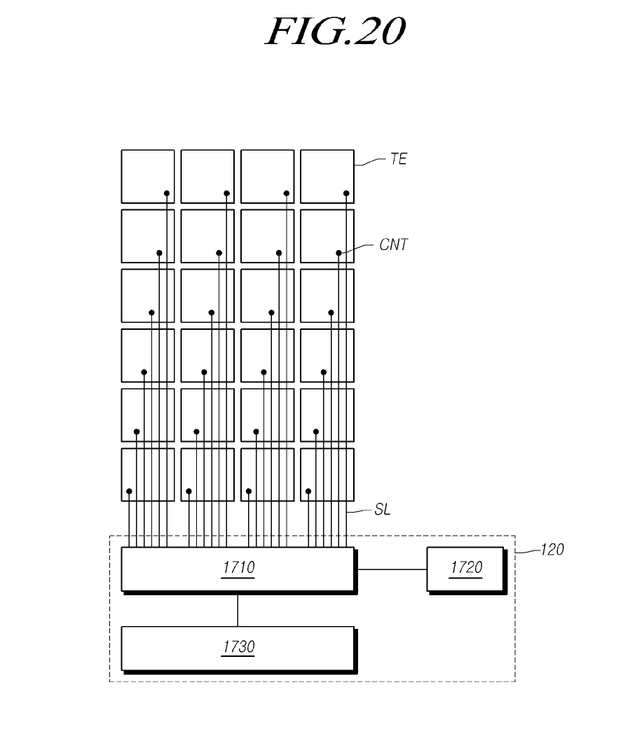

FIG. 20 is a diagram illustrating the touch sensing circuit of the touch display device according to the exemplary embodiments.

Referring to FIG. 20, the touch sensing circuit 120 is a circuit for sensing a touch in the touch display device 100 having two operation modes including the display mode for displaying an image and the touch mode for sensing a touch.

Referring to FIG. 20, the touch sensing circuit 120 includes a driving circuit 1710 that outputs touch driving signals TDS and LFDS of a pulse type for sequentially driving at least one of plural touch electrodes TE and a sensing circuit 1720 that detects a capacitance variation in each of the touch electrodes TE to sense a touch or a touch position

The driving circuit 1710 is electrically connected to the touch electrodes TE via signal lines SL.

Here, the touch electrodes TE can be connected to the signal lines SL located in a different layer via contact holes CNT.

The driving circuit 1710 performs the touch driving based on waveform modulation.

Each touch section for the touch mode may include two or more continuous unit touch sections.

The touch driving signals TDS and FLDS output in the two or more unit touch sections may include plural waveforms (pulses) and the waveforms may have the same frequency or different frequencies.

The touch sensing circuit 120 may further include a signal generating circuit 1730 that generates the touch driving signals TDS and LFDS including waveforms having two or more different amplitude levels through the waveform modulating process. That is, the touch display device 100 according to the exemplary embodiments, the first touch driving signal TDS to be supplied to one touch electrode TE and the second touch driving signal LFDS to be supplied to at least one of another touch electrode adjacent to the touch electrode TE, the gate line GL, and the data line DL can be supplied from the signal generating circuit 1730.

The exemplary embodiments are not limited to this example, but the first touch driving signal TDS of the touch driving signal may be supplied from the signal generating circuit 1730 and the second touch driving signal LFDS may be supplied to the touch display device 100 from one of the signal generating circuit 1730, the gate driver, and the data driver.

By employing the touch sensing circuit 120, it is possible to suppress EMI intensity by the touch driving based on waveform modulation.

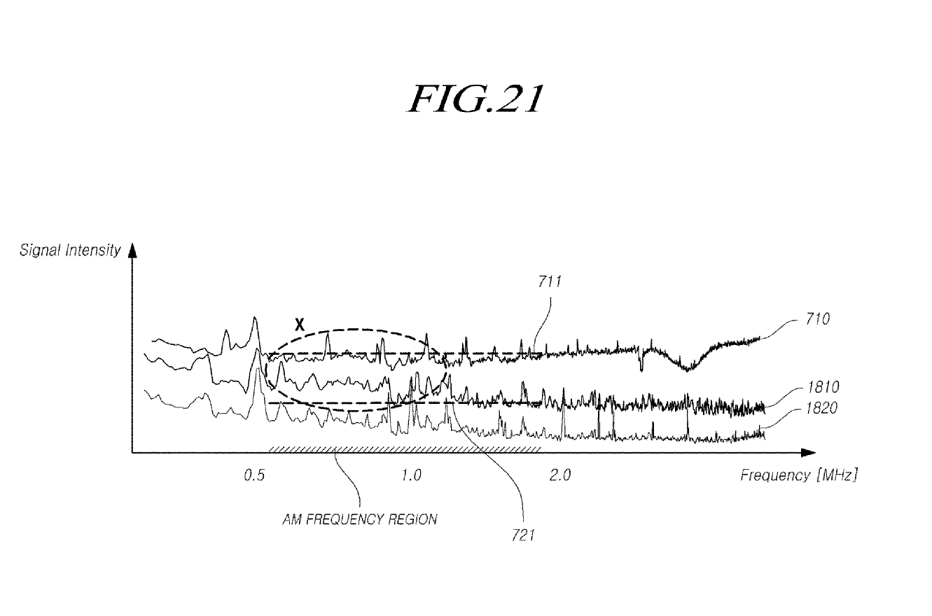

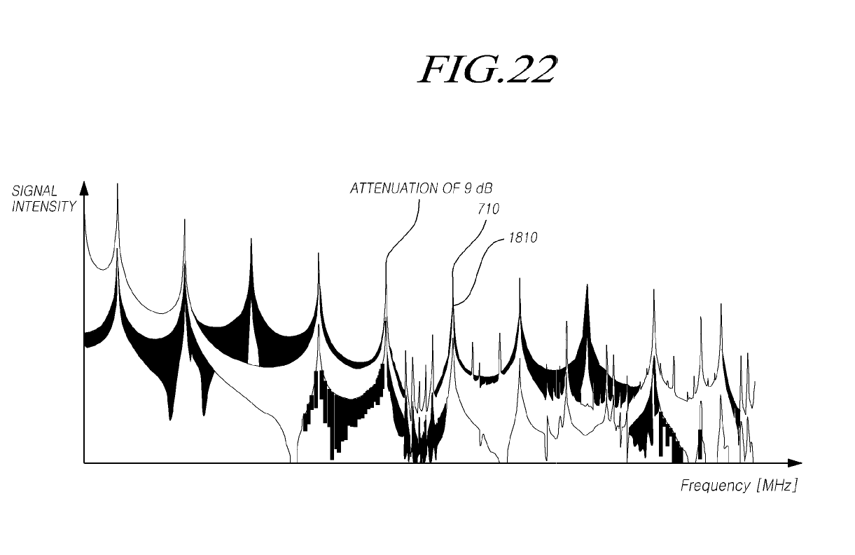

FIG. 21 is a diagram illustrating an EMI suppression effect in the touch display device according to the exemplary embodiments. FIG. 22 is an enlarged view of an X region in FIG. 21.

Referring to FIG. 21, when the touch display device 100 is driven using the touch driving signals TDS and LFDS having a single frequency of 100 KHz (the frequency of each of the plural waveforms is 100 KHz), it can be seen that EMI generated in an amplitude modulation (AM) frequency region (for example, about 500 KHz to about 1,605 KHz) is relaxed by the touch driving based on waveform modulation according to the exemplary embodiments.

FIG. 21 is a graph which is obtained by measuring intensity of an EMI signal by frequencies and in which an upper-limit measured value 1810 and an average measured value 1820 of EMI signals are arranged by frequencies.

As the measurement result, it can be seen that positions (712 of 710 in FIG. 7, corresponding to EMI) at which the upper-limit measured value 1810 of the EMI signals is greater than a upper-limit reference value 711 which is a minimum upper limit value for satisfying an EMI condition in the AM frequency region are removed.

By using the touch driving signals TDS and LFDS having different amplitude levels used in the waveform modulation driving method according to the exemplary embodiments, it can be seen that the EMI intensity is more suppressed than that when the touch driving signals TDS and LFDS having a single amplitude level. The degree of relaxation of EMI varies depending on the touch driving signals TDS and LFDS having two or more amplitude levels, the touch driving signals TDS and LFDS having a trapezoidal waveform, and the touch driving signals TDS and LFDS having a triangular waveform which have been described with reference to FIGS. 9 to 16, but about 9 dB is relaxed.

Referring to FIG. 22, regarding the EMI intensity in the X region, it can be seen that the upper-limit measured value 1810 of the EMI signal according to the exemplary embodiments is less than the upper-limit measured value 710 of the EMI signal according to the related art illustrated in FIG. 7.

That is, it is possible to satisfy the EMI condition to match the upper-limit measured value 1810 and the average measured value 1820 of the EMI signals in the AM frequency region by applying the waveform modulation driving according to the exemplary embodiments to the touch display device.

According to the above-mentioned exemplary embodiments, it is possible to provide a driving method, a touch sensing circuit (120), and a touch display device (100) that can prevent electromagnetic interference (EMI).

Accordingly, it is possible to prevent deterioration in system stability, display performance, and touch sensing performance due to EMI.

According to the exemplary embodiments, it is possible to provide a driving method, a touch sensing circuit 120, and a touch display device 100 that can prevent EMI in a touch section and prevent unnecessary parasitic capacitance from being generated.

According to the exemplary embodiments, it is possible to provide a driving method, a touch sensing circuit 120, and a touch display device 100 that can perform touch driving using a waveform modulation driving method capable of preventing EMI.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A touch display device having a display panel including a plurality of sub pixels and having a display mode for displaying an image and a touch sensing mode for sensing a touch, the touch display device comprising:
a plurality of touch electrodes that are arranged outside or inside the display panel; and
a touch sensing circuit that outputs a touch driving signal to drive at least one of the plurality of touch electrodes and senses a touch or a touch position,
wherein the touch driving signal output in each touch section for the touch mode includes a plurality of waveforms to which a rectangular wave is modulated, and
each of the plurality of waveforms includes one or more different amplitudes in a rising section and a falling section.

2. The touch display device according to claim 1, wherein the touch driving signal includes a first touch driving signal that is supplied to one touch electrode and a second touch driving signal that is supplied to at least one of another touch electrode adjacent to the touch electrode, a gate line, and a data line.

3. The touch display device according to claim 2, wherein each of the first and second touch driving signals of the touch driving signal includes a plurality of waveforms to which a rectangular wave is modulated, and each of the plurality of modulated waveforms has at least two different amplitude levels.

4. The touch display device according to claim 2, wherein only one of the first and second touch driving signals of the touch driving signal includes a plurality of waveforms to which a rectangular wave is modulated and each of the plurality of modulated waveforms has at least two different amplitude levels.

5. The touch display device according to claim 2, wherein each waveform of the first and second touch driving signals of the touch driving signal includes a high section and a low section in one period, and
each waveform has different amplitude levels of a step shape in the high section.

6. The touch display device according to claim 2, wherein each waveform of the first and second touch driving signals of the touch driving signal includes a high section and a low section, and
the amplitude varies to have a predetermined gradient in the high section.

7. The touch display device according to claim 6, wherein the predetermined gradient of the amplitude in the high section ranges from 45 degrees to 80 degrees with respect to the low section.

8. The touch display device according to claim 2, wherein a plurality of waveforms of the first and second touch driving signals of the touch driving signal have different frequencies.

9. The touch display device according to claim 1, wherein a display section for the display mode and a touch section for the touch mode are temporally separated from each other, and
one frame section includes one display section and one touch section or includes two or more display sections and one or more touch sections.

10. The touch display device according to claim 2, wherein a plurality of waveforms of the first and second touch driving signals of the touch driving signal are trapezoidal waveforms or triangular waveforms.

11. The touch display device according to claim 1, further comprising a lookup table that stores waveform modulation information,
wherein each of a plurality of waveforms to which a rectangular wave is modulated in the touch driving signal output in each touch section is modulated on the basis of the waveform modulation information stored in the lookup table.

12. The touch display device according to claim 1, wherein the touch sensing circuit changes a waveform of the touch driving signal to a waveform in which noise is avoided as a noise measurement result in modulating the waveform of the touch driving signal.

13. A driving method of a touch display device having a display panel including a plurality of sub pixels and having a display mode for displaying an image and a touch sensing mode for sensing a touch, the driving method comprising:
a display driving step of driving data lines and gate lines in a display section for the display mode; and
a touch driving step of outputting a touch driving signal for driving at least one of a plurality of touch electrodes arranged outside or inside the display panel in a touch section for the touch mode,
wherein the touch driving step includes
converting a rectangular wave of the touch driving signal into a plurality of waveforms of which amplitude is modulated in the touch section, and
outputting the touch driving signal including the plurality of waveforms of which amplitude is modulated,
wherein each of the plurality of waveforms includes one or more different amplitudes in a rising section and a falling section.

14. The driving method according to claim 13, wherein the touch driving signal includes a first touch driving signal that is supplied to one touch electrode and a second touch driving signal that is supplied to at least one of another touch electrode adjacent to the touch electrode, the gate line, and the data line.

15. The driving method according to claim 14, wherein each waveform of the first and second touch driving signals of the touch driving signal includes a high section and a low section in one period, and
each waveform has different amplitude levels of a step shape in the high section.

16. A touch sensing circuit that is included in a touch display device having a display mode for displaying an image and a touch sensing mode for sensing a touch, the touch sensing circuit comprising:
a driving circuit that outputs a touch driving signal for driving at least one of a plurality of touch electrodes; and
a sensing circuit that detects a capacitance variation in each of the plurality of touch electrodes and senses a touch or a touch position,
wherein the touch driving signal output in each touch section for the touch mode includes a plurality of waveforms to which a rectangular wave is modulated, and
each of the plurality of waveforms includes one or more different amplitudes in a rising section and a falling section.

17. The touch sensing circuit according to claim 16, wherein the touch driving signal includes a first touch driving signal that is supplied to one touch electrode and a second touch driving signal that is supplied to at least one of another touch electrode adjacent to the touch electrode, a gate line, and a data line.

18. The touch sensing circuit according to claim 17, further comprising a signal generating circuit that generates a driving signal such that each waveform of the first and second touch driving signals of the touch driving signal has two or more different amplitudes.

19. The touch sensing circuit according to claim 17, wherein each waveform of the first and second touch driving signals of the touch driving signal includes a high section and a low section in one period, and
each waveform has different amplitude levels of a step shape in the high section.
